(19) United States
(12) Patent Application Publication
(10) Pub. No.: US 2006/0193957 A1
(43) Pub. Date: Aug. 31, 2006

(54) Brown sugar substitute

(76) Inventor: William J. Chapello, Atlantic Highlands, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/171,094

(22) Filed: Jun. 30, 2005

Related U.S. Application Data
(60) Provisional application No. 60/657,209, filed on Feb. 28, 2005.

(51) Int. Cl. A23L 1/236

(52) U.S. Cl. 426/548

(57) ABSTRACT

A brown sugar substitute containing a high intensity sweetener, molasses, and a food grade crystalline sugar or sugar alcohol. Compositions containing the brown sugar substitutes and packaged forms of the brown sugar substitutes are also provided. Further provided are methods of making the brown sugar substitutes.

This application claims benefit under 35 U.S.C. § 119(e) of U.S. Provisional Application No. 60/657,209, filed Feb. 28, 2005.

### FIELD OF THE INVENTION

The present invention relates to brown sugar substitute compositions containing a food-grade crystalline sugar or sugar alcohol, molasses, and a high intensity sweetener. The present invention also relates to methods of producing such brown sugar substitutes.

The brown sugar substitute compositions of the present invention may be used in all applications in which brown sugar can be used.

### BACKGROUND OF THE INVENTION

People often customize the taste of food and beverages by adding sweeteners thereto. For example, sweeteners are added to beverages, such as, coffee and tea; on cereals; on fruit; as toppings on baked goods, and in many other ways. Sweetening a food or beverage alters its flavor and usually increases its appeal. This behavior is found in all cultures, but is especially prevalent in western cultures.

The most common sweeteners are nutritive sweeteners. Nutritive sweeteners not only provide sweetness, but are also absorbable into the bloodstream and may be metabolized to provide energy for immediate use or for storage as fat. Nutritive sweeteners are typically extracted from plants that produce them in various quantities and for various purposes. For example, sucrose, a nutritive sweetener in wide spread use, is produced from, e.g., sugar cane and sugar beet roots.

Sugar alcohols are another form of sweetener. Sugar alcohols are chemically alcohols, but are derived from sugar molecules. Sugar alcohols vary in sweetness from half as sweet to about as sweet as sucrose. Accordingly, sugar alcohols may be used in place of sugar. Sugar alcohols have about one-half to three-quarters the amount of calories of sugar on a per weight basis. Sugar alcohols are slowly and incompletely absorbed from the small intestine into the blood. Absorbed sugar alcohols are converted to energy by processes that require little or no insulin. Accordingly, these sweeteners may be used by diabetics or those on low-carbohydrate diets.

High intensity sweeteners are well known alternatives to nutritive sweeteners. High intensity sweeteners provide sweetness without the calories and other metabolic impacts of the nutritive sweeteners. In many cases, high intensity sweeteners provide a sweet flavor that is preferred to, e.g., nutritive sweeteners. Some high intensity sweeteners, such as, aspartame, are nutritive, but are so intense that they still provide negligible calories because very small amounts are required. Other high intensity sweeteners, such as, for example sucralose, are not absorbed when ingested and are therefore non-nutritive sweeteners.

Other sweetener compositions are also available as blends of two or more sweeteners. Brown sugar is an example of this type of sweetener. Brown sugar usually contains, in addition to pure sucrose as the principle constituent, a coating of molasses, which imparts the distinctive flavor and color to this type of sweetener. The molasses, which is composed of sucrose, invert sugar, ash, water, and other crystallizable and non-crystallizable compounds, surrounds the pure sucrose crystals in the form of a thin film. Brown sugar is used, for example, in the home and in the food industry to develop a rich molasses-type flavor in, e.g., cookies, candies, and similar products. True raw sugars are similar to brown sugar, but may have the molasses-like components distributed in inclusions in the sucrose crystalline matrix, as well as on the surface.

Many sugar refiners produce brown sugar by boiling sugar cane syrup until brown sugar crystals are formed. A centrifuge spins the crystals dry. Some of the syrup remains on the sucrose crystals giving the sugar its brown color and molasses flavor. Other manufacturers produce brown sugar by blending a sugar cane molasses syrup with white sugar crystals.

The traditional sucrose-molasses brown sugar products have a high caloric content—typically about 4 kcal per gram. In a recipe calling for 300 grams of traditional sucrose-molasses brown sugar, 1,200 kcals will be added. Accordingly, efforts have been made to reduce the caloric burden of traditional sucrose-molasses brown sugar.

One such effort is found in the Brown SWEET 'N LOW® brand. This product contains nutritive dextrose, natural molasses flavor, 3.6% Saccharin (18 milligrams per teaspoon of sugar sweetening equivalence), caramel color, cream of tartar, and calcium silicate. This product has about 80 kcals per 1 cup brown sugar equivalent (8 teaspoons brown SWEET 'N LOW per 1 cup brown sugar equivalent). However, this product uses molasses flavor, rather than molasses, due to the effect of the high water content of the molasses on the structure of the low calorie formulation. The molasses flavor allows for a dry form of the product, which is necessary to provide for consistent measurement and ease of packaging of the product. However, the use of molasses flavor results in a product with a less than desirable flavor.

In view of the foregoing, it would be desirable to provide a brown sugar substitute with a reduced caloric burden while maintaining the full taste, functionality, and physical properties of traditional sucrose-molasses brown sugar that are well known to, and accepted by, consumers. These and other objects of the present invention are described in greater detail below.

### SUMMARY OF THE INVENTION

The present invention provides a brown sugar substitute composition containing from about 0.01 to about 3% by weight of a high intensity sweetener, from about 1 to about 16% by weight of molasses and from about 70 to about 99% by weight of a food grade crystalline sugar or sugar alcohol.

The present invention also provides a brown sugar substitute composition containing from about 80 to about 95% by weight of a food grade crystalline sugar or sugar alcohol, from about 4 to about 16% by weight of molasses, and from about 0.01 to about 3% by weight of a high intensity sweetener, wherein less than about 3.5 kcals per gram of sucrose equivalent sweetness are delivered.

The present invention further provides a method of making a brown sugar substitute composition. This method includes forming a light formulation by combining from about 0.01 to about 3% by weight of a high intensity sweetener, from about 1 to about 16% by weight of molasses. Thereafter, from about 70 to about 99% of a food grade crystalline sugar or sugar alcohol is mixed into the light formulation to form a brown sugar substitute composition.

### DETAILED DESCRIPTION OF THE INVENTION

The present application is directed to the production of a brown sugar substitute composition by adding a food grade crystalline sugar or sugar alcohol to a molasses-containing light formulation. Unexpectedly and surprisingly, the resulting brown sugar substitute exhibits an improved flavor and a consumer preferred wet texture.

In the present invention, the phrases “brown sugar substitute” and “brown sugar substitute composition” are used interchangeably.

As used herein, “crystalline sugar” means any white crystalline carbohydrate that is soluble in water and generally has a sweet taste. Any crystalline sugar known to those skilled in the art can be used in the present invention. The sugar may be a monosaccharide or a disaccharide. Examples of useful monosaccharides include erythrose, threose, arabinose, ribose, ribulose, xylose, xylulose, lyxose, allose, altrose, fructose, galactose, glucose (dextrose), culose, idose, mannose, sorbose, talose, tagatose, and sedoheptulose. Examples of useful disaccharides include sucrose, lactose, maltose, and trehalose. A preferred crystalline sugar is sucrose.

Well-known processes are used to extract and purify sucrose from sugar cane, sugar beets, and other plants. Other sugars, such as, glucose (dextrose) and fructose, can also be produced from various grain plants by well-known processes.

As used herein, “sugar alcohol” means an alcohol derived from a sugar molecule. Sugar alcohols useful in the present invention include, for example, mannitol, sorbitol, lactitol, isomalt, erythritol, xylitol, maltitol, and the like.

As used herein, a “food grade crystalline sugar or sugar alcohol” is a crystalline sugar or sugar alcohol that conforms to the standards for foods deemed safe for human consumption set forth in the Codex Alimentarius produced by the World Health Organization (1999).

As used herein, the term “high intensity sweetener” means a substance that provides a high sweetness per unit mass as compared to a nutritive sweetener and provides little or no nutritive value. Many high intensity sweeteners are known to those skilled in the art and any can be used in the present invention. Examples of high intensity sweeteners for use in the present invention include aspartame, acesulfame K, saccharine, cyclamate, neotame, sucralose, brazien and other protein based sweeteners, such as for example stevia and other plant extracts, and various salts and derivatives thereof. A preferred sweetener according to the present invention is sucralose. High intensity sweeteners are available in various forms, including cubes, tablets, granules, and liquids.

The intensity of a sweetener may be assessed by determining the amount of the sweetener required to provide a sweetness comparable to a predetermined mass of a natural sugar, e.g., sucrose. In the present invention, this parameter is expressed in terms of “sucrose equivalent sweetness.” For example, if a sweetener is twice as intense as sucrose, 0.5 g of the sweetener would equal a gram of sucrose equivalent sweetness.

The brown sugar substitute compositions of the present invention may provide a wide range of sweetness intensities from a fraction of that of sucrose to many times that of sucrose. In one embodiment of the present invention, a teaspoon of the brown sugar substitute delivers from about 1.1 to about 8 sucrose equivalent teaspoons of sweetness. Preferably, a teaspoon of the brown sugar substitute delivers from about 1.5 to about 4, and more preferably, about 2 sucrose equivalent teaspoons of sweetness.

Another component of the brown sugar substitute compositions is molasses. Molasses is a syrup produced during the refining of sugar, having sucrose, invert sugar, ash, water, and other crystallizable and non-crystallizable compounds as its major constituents. There are three major grades of molasses: first molasses, second molasses, and blackstrap molasses. During processing, sugar cane, for example, is harvested and stripped of its leaves. The juice is then extracted from the canes, boiled until it has reached the appropriate consistency, and processed to extract the sugar. The syrup remaining after this first boiling and processing is first molasses, which has the highest sugar content because a relatively high amount of sugar remains in the juice. Second molasses is created from a second boiling and sugar extraction and has a slightly bitter taste. Additional rounds of processing and boiling produce blackstrap molasses. Although not all are equally preferred by bakers and consumers, any grade of molasses can be used in the present invention.

The quality of molasses depends on the maturity of the sugar cane, the amount of sugar extracted, and the method of extraction. There are three major types of molasses: unsulphured, sulphured, and blackstrap.

Unsulphured molasses is the finest quality. It is made from the juice of sun-ripened cane and the juice is clarified and concentrated. Sulphured molasses is made from green (unripe) sugar cane and is treated with sulphur fumes during the sugar extraction process. In the present invention, any type of molasses may be used.

In the present invention, the brown sugar substitute compositions contain from about 1 to about 16% by weight of molasses. Preferably, the brown sugar substitute compositions contain from about 4 to about 16% by weight of molasses. More preferably, the brown sugar compositions contain from about 4 to about 12% by weight of molasses, such as for example from about 5 to about 7% by weight of molasses.

Moisture is an important consideration in a brown sugar product. A range of moisture levels is possible, from about 0.1% moisture to about 5% moisture. The most preferred brown sugar products are those where the moisture is provided by the molasses and therefore contains all the molasses flavor notes.

The brown sugar substitutes of the present invention may also include one or more flavors. Any natural or artificial flavor known in the art may be used to highlight the taste of the brown sugar substitute of the invention to account for the natural variation in the molasses used.

The present invention may be delivered in any packaged form typically used for delivering brown sugar. Generally, the brown sugar substitute can be packaged for industrial or commercial use, such as in the food services industry, or for use by consumers in the same manner as brown sugar. These packaged forms may include, for example, boxes, bags, drums, tubs, and the like, and individual use (i.e., unit package) forms, such as packets.

Moreover, the brown sugar substitute of the present invention may be incorporated into premixed food or beverage preparations in the same manner as brown sugar. Food preparations may include, for example, cookie or cake mix and cookie dough. Preparations of this type will provide the same convenience as those containing brown sugar, but have the advantage of delivering fewer calories.

Another embodiment of the present invention is a brown sugar substitute containing from about 80 to about 95% by weight of a food grade crystalline sugar or sugar alcohol, from about 4 to about 16% by weight of molasses, and from about 0.01 to about 3% by weight of a high intensity sweetener, wherein less than about 3.5 kcals per gram of sucrose equivalent sweetness are delivered. In this embodiment, the crystalline sugar or sugar alcohol, molasses, and high intensity sweeteners may be used in the manner and amounts previously described.

In the present invention, any conventional combining step may be used. For example, to form the light formulation, the molasses is heated and combined with the high intensity sweetener and, optionally, any desired flavor, to form a slurry. The components of the light formulation may be combined by any means known in the art to form a slurry. Preferably, the components are blended. The molasses is heated to about 90° F. to about 150° F., preferably to about 90° F. to about 140° F., most preferably to about 120° F.

The food grade crystalline sugar or sugar alcohol is then coated with the slurry. The coating may be accomplished by any means known in the art. Preferably, the slurry is poured or sprayed onto the food grade crystalline sugar while mixing or the slurry is blended with the food grade crystalline sugar.

The amount and identity of the high intensity sweetener, molasses, and food grade crystalline sugar or sugar alcohol used in this method are as described above.

The following examples are provided to further illustrate the compositions and methods of the present invention. These examples are illustrative only and are not intended to limit the scope of the invention in any way.

### EXAMPLES

### Brown Sugar Substitute

### Example 1

Three 100 lb. batches of a brown sugar substitute are made by combining 0.88 lbs. of a flavor/sucralose/water pre-blend which contains about 0.0852 lb Robertet NV-12,294 (Robertet Flavors, Piscataway, N.J.), about 0.0284 lb Robertet NV-23,601, about 0.25 lb sucralose, and about 0.6364 lb water, about 7.00 lbs. of molasses (Paulaur Corp., Cranbury, N.J.—lot # 800002), and about 92.12 lbs of sucrose (Extra Fine, Fruit, or Bakers Special granulation) (Domino Sugar, Baltimore, Md.). The molasses is pre-heated to about 140° F. and blended with the pre-blend to form a slurry. The resulting slurry is poured directly onto the sucrose (while mixing) over a period of approximately one minute. The mixer is an 8-cu/ft pilot plant ribbon blender operated at about 91 rpm.

The mixer is stopped about 4 to about 5 minutes after the slurry is added to the sucrose. Thereafter, approximately half of the product is removed and packed in 50 lb. boxes with two 2 mil polyethylene liners.

The remaining product is blended for approximately 5 to 6 additional minutes then removed from the mixer and packed in 50 lb. boxes with two 2 mil polyethylene liners.

### Example 2

A 100 lb. batch of a brown sugar substitute is made with about 0.88 lbs. of a flavor/sucralose/water pre-blend which contains about 0.0852 lb Robertet NV-12,294, about 0.0284 lb Robertet NV-23,601, about 0.25 lb sucralose, and about 0.6364 lb water, about 7.00 lbs. of molasses (Paulaur lot # 800002), and about 92.12 lbs of sucrose (Domino Fine Sugar). The molasses is pre-heated to about 140° F. and blended with the pre-blend to form a slurry. The slurry is sprayed (at 85 psi using two QPT-6550 wide spray tips) onto the sucrose (while mixing) over approximately two minutes. The mixer is an 8-cu/ft pilot plant ribbon blender operated at 91 rpm.

The mixer is stopped about 4 to about 5 minutes after the slurry is added to the sucrose. Samples are obtained from 4 points. Thereafter, approximately half of the product is removed and packed in 50 lb. boxes with two 2 mil polyethylene liners.

The remaining product is blended for approximately 5 to 6 additional minutes then removed from the mixer and packed in 50 lb. boxes with two 2 mil polyethylene liners.

### Example 3

About twenty-four hours prior to use, a slurry is produced by mixing about 2.86 lbs. of neat sucralose (Tate & Lyle, Decatur, Ill.) into about 91 lbs. of molasses (Paulaur lot # 800002) and heated to about 140° F. Immediately before use, two flavors (0.975 lbs. of Robertet NV-12,294 & 0.325 lbs. of NV-23,601) are blended into the slurry using a high shear mixer (ARDE-BARINCO, #1006, Norwood, N.J.) (65 rpm) for one minute. The slurry is maintained at about 140° F. until use.

A 1300 lb. batch of a brown sugar substitute is made with about 95 lbs. of the above slurry and about 1205 lbs. of extra fine sucrose (Domino Sugar). The slurry is added directly to the sugar in a blender over the course of 6 minutes while the blender is operating. The blender is a 100-gallon horizontal cylindrical blender operating at 25 rpm (McCarter, Norristown, Pa.). Immediately following slurry addition, a portion of the blend material (about 25 lbs.) is removed from the blender outlet and recycled back into the batch.

After about 40 minutes of mixing, the product is packed into drums with two 2 mil polyethylene liners (about 300 lbs/drum).

### Example 4

About twenty-four hours prior to use, a slurry is produced by mixing about 5.95 lbs. of neat sucralose (Tate & Lyle) into about 189 lbs. of molasses (Paulaur lot # 800002) and heated to about 140° F. Immediately before use, two flavors (about 2.025 lbs. of Robertet NV-12,294 & about 0.675 lbs. of NV-23,601) are blended into the slurry with a small propeller mixer 71636819 type 63 (Neptune Mixer Co., Lansdale, Pa.) set at 60 rpm for about one minute. The slurry is maintained at about 140° F. until use.

A 2700 lb. batch of a brown sugar substitute is made with about 198 lbs. of the above slurry and about 2502 lbs. of extra fine sucrose (Domino Sugar). The slurry is added directly to the sugar in a blender over the course of 6 minutes while the blender is operating. The blender is a 120-cu/ft-paddle blender operated at about 25 rpm. Immediately following slurry addition, a portion of the blend material (about 150 lbs.) is removed from the blender outlet and recycled back into the batch.

After about 10 minutes of mixing, one drum (about 300 lbs.) is immediately removed from the batch.

After a total mix time of about 26 minutes, the remaining product is packed into a 42-cu/ft-polyethylene bin and drums with two 2 mil polyethylene liners. The blender discharge takes about 12 minutes.

The scope of the present invention is not limited by the description, examples and suggested uses herein and modifications can be made without departing from the spirit of the invention. Thus, it is intended that the present invention cover modifications and variations of this invention provided that they come within the scope of the appended claims and their equivalents.

What is claimed is:

1. A brown sugar substitute comprising:
from about 0.01 to about 3 wt % high intensity sweetener;
from about 1 to about 16 wt % molasses; and
from about 70 to about 99 wt % of a food grade crystalline sugar or sugar alcohol.

2. A brown sugar substitute according to claim 1, wherein the high intensity sweetener is selected from the group consisting of aspartame, acesulfame K, saccharine, cyclamate, neotame, sucralose, brazien, stevia, various salts thereof, and mixtures thereof.

3. A brown sugar substitute according to claim 2, wherein the high intensity sweetener is sucralose.

4. A brown sugar substitute according to claim 1, comprising from about 4 to about 12 wt % of molasses.

5. A brown sugar substitute according to claim 1, comprising from about 5 to about 7 wt % molasses.

6. A brown sugar substitute according to claim 1, wherein the food grade crystalline sugar is sucrose.

7. A brown sugar substitute according to claim 1, wherein a teaspoon of the brown sugar substitute provides between about 1.1 and about 8 sucrose equivalent teaspoons of sweetness.

8. A brown sugar substitute according to claim 7, wherein a teaspoon of the brown sugar substitute provides between about 1.5 and about 4 sucrose equivalent teaspoons of sweetness.

9. A brown sugar substitute according to claim 8, wherein a teaspoon of the brown sugar substitute provides about 2 sucrose equivalent teaspoons of sweetness.

10. A brown sugar substitute according to claim 1, further comprising a flavor.

11. A brown sugar substitute according to claim 1 dispersed within a packaged form.

12. A brown sugar substitute according to claim 11, wherein the packaged form is selected from the group consisting of boxes, bags, drums, tubs, and individual use packets.

13. A brown sugar substitute comprising:
from about 80 to about 95 wt % of a food grade crystalline sugar or sugar alcohol;
from about 4 to about 16 wt % molasses; and
from about 0.01 to about 3 wt % of a high intensity sweetener,
wherein less than about 3.5 kcals per gram of sucrose equivalent sweetness are delivered.

14. A brown sugar substitute according to claim 13, wherein the high intensity sweetener is selected from the group consisting of aspartame, acesulfame K, saccharine, cyclamate, neotame, sucralose, brazien, stevia, various salts thereof, and mixtures thereof.

15. A brown sugar substitute according to claim 14, wherein the high intensity sweetener is sucralose.

16. A brown sugar substitute according to claim 13, wherein the food grade crystalline sugar is sucrose.

17. A method of making a brown sugar substitute comprising:
forming a light formulation by combining:
from about 0.01 to about 3 wt % high intensity sweetener;
from about 1 to about 16 wt % molasses; and
mixing from about 70 to about 99 wt % of a food grade crystalline sugar or sugar alcohol into the light formulation to form a brown sugar substitute.

18. A method according to claim 17, wherein the high intensity sweetener is selected from the group consisting of aspartame, acesulfame K, saccharine, cyclamate, neotame, sucralose, brazien, stevia, various salts thereof, and mixtures thereof.

19. A method according to claim 18, wherein the high intensity sweetener is sucralose.

20. A method according to claim 17, wherein the food grade crystalline sugar is sucrose.

21. A method according to claim 17 further comprising adding a flavor to the light formulation prior to the mixing step.
